(19) United States
(12) Patent Application Publication
(10) Pub. No.: US 2015/0019400 A1
(43) Pub. Date: Jan. 15, 2015

(54) FLEXIBLE PAYMENT LOAN METHODS AND SYSTEMS

(71) Applicant: San Diego County Credit Union, San Diego, CA (US)

(72) Inventor: Patrick Cosgrove, San Diego, CA (US)

(73) Assignee: San Diego County Credit Union, San Diego, CA (US)

(21) Appl. No.: 13/939,135

(22) Filed: Jul. 10, 2013

(51) Int. Cl. G06Q 20/24

(52) U.S. Cl. CPC G06Q 20/24; G06Q 40/025
USPC 705/38

(57) ABSTRACT

Flexible payment loan methods and systems are provided. When approved for a flexible payment loan, a user may skip making loan payments in a set of loan skipping periods without penalty. The set of loan skipping payment periods may be predetermined and may comprise the summer months of July and August. Interest may continue to accrue in the loan skipping periods when the user skips payments. In each review period, the condition of a flexible payment loan is validated. A user may continuously skip payments only if the flexible payment loan is in good standing.

### TECHNICAL FIELD

The present application relates generally to financial systems, and more particularly, some embodiments relate to flexible payment loan methods and systems.

### DESCRIPTION OF THE RELATED ART

A loan is a debt evidenced by a note which specifies, among other things, the principal amount, the interest rate, and the date of payment. A loan entails the reallocation of the subject asset for a period of time, between the lender and the borrower. The borrower is required to make the payment on time before or on the date of payment. A late payment usually results in interest, finance charges, penalties, and other charges. Such a rigorous loan payment structure does not recognize that a borrower may experience financial difficulties and finance obligations during the loan period and is unable to make the payment on time.

### BRIEF SUMMARY OF THE APPLICATION

According to various embodiments of the application, flexible payment loan methods and systems are provided. When approved for a flexible payment loan, a user may skip making loan payments in a set of loan skipping periods without penalty. In some embodiments, a user may specify the loan skipping periods. In other embodiments, the set of loan skipping periods are predetermined and cannot be changed. In various embodiments, interest continues to accrue in the loan skipping periods when the user skips payments. In each review period, the condition of a flexible payment loan is validated. According to one embodiment, a user may continuously skip payments only if the flexible payment loan is in good standing.

Other features and aspects of the application will become apparent from the following detailed description, taken in conjunction with the accompanying drawings, which illustrate, by way of example, the features in accordance with embodiments of the application. The summary is not intended to limit the scope of the application, which is defined solely by the claims attached hereto.

### BRIEF DESCRIPTION OF THE DRAWINGS

The present application, in accordance with one or more various embodiments, is described in detail with reference to the following figures. The drawings are provided for purposes of illustration only and merely depict typical or example embodiments of the application. These drawings are provided to facilitate the reader's understanding of the application and shall not be considered limiting of the breadth, scope, or applicability of the application. It should be noted that for clarity and ease of illustration these drawings are not necessarily made to scale.

FIG. 1 illustrates an exemplary environment in which an embodiment may be implemented.

FIG. 2 is a flow diagram illustrating an exemplary method of processing a flexible payment loan application in accordance with an embodiment.

FIG. 3 is a flow diagram illustrating an exemplary method of validating the condition of a flexible payment loan in accordance with an embodiment.

FIG. 4 illustrates an example computing module that may be used in implementing various features of embodiments of the application.

The figures are not intended to be exhaustive or to limit the application to the precise form disclosed. It should be understood that the application can be practiced with modification and alteration, and that the application be limited only by the claims and the equivalents thereof.

### DETAILED DESCRIPTION OF THE EMBODIMENTS OF THE APPLICATION

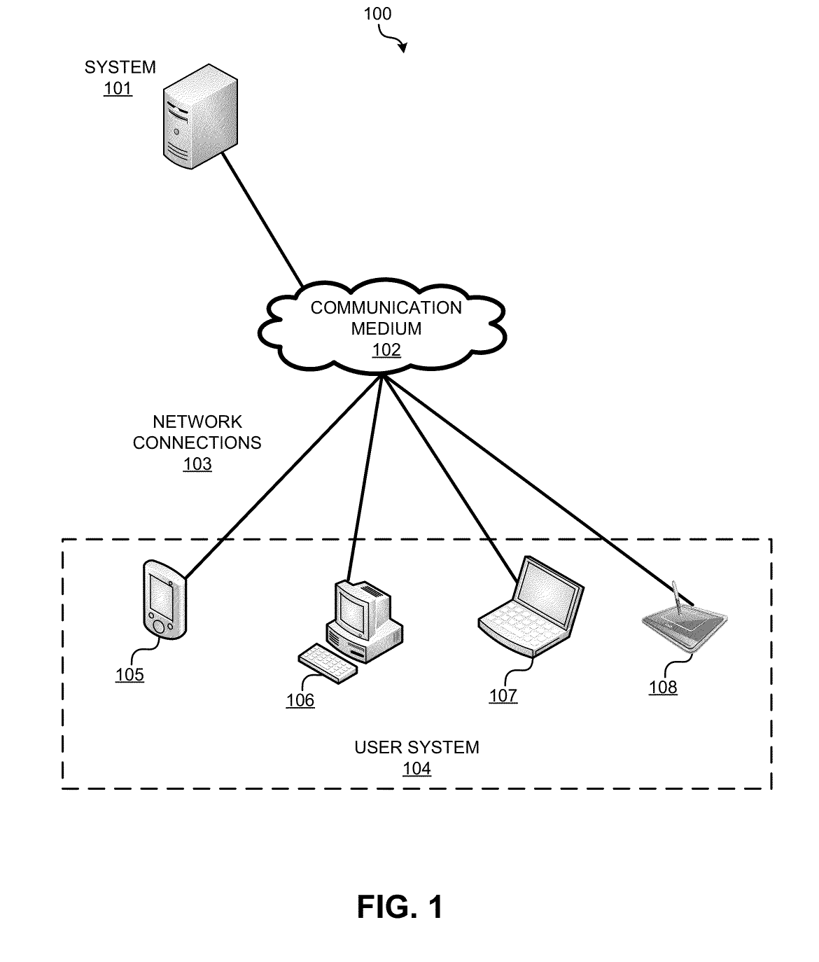

Before describing the application in detail, it is useful to describe an example environment in which the application can be implemented. One such example is illustrated in FIG. 1.

FIG. 1 illustrates an exemplary flexible payment loan system 101 implemented in an environment 100 comprising various user devices 105-108, which may be collectively referred to as a user system 104 connected via a communication medium 102. The flexible payment loan system 101 may provide flexible loan application and processing, loan payment processing and calculation, and users may apply for the loan and make payments to the flexible payment loan system 101 by using various user devices 105-108. In another embodiment, the flexible payment loan system 101 may provide a loan payment reminder, a loan balance summary, and other services to a financial institution (not shown), from which users may apply for a loan. In some embodiments, the communication medium may be a wired system, such as a coaxial cable system, a fiber optic cable system, an Ethernet cable system, or other similar communication medium. Alternatively, the communication medium may be a wireless network system, such as a wireless personal area network, a wireless local area network, a cellular network, or other similar communication medium.

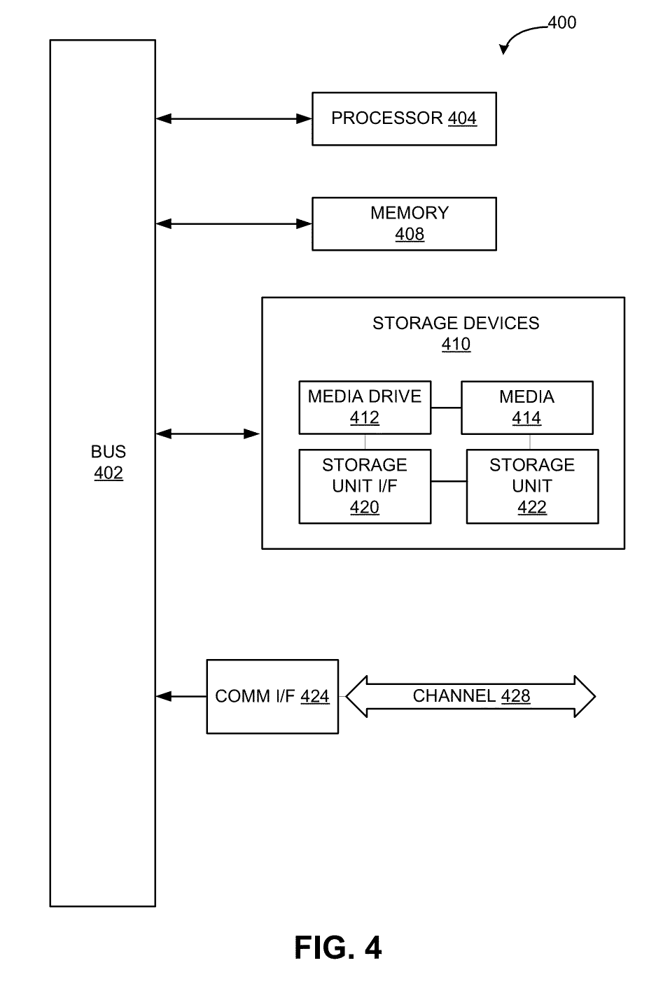

As shown, user system 104 may comprise a smartphone 105 (e.g., iPhone®), a desktop computer 106, a laptop computer 107, and/or a tablet 108 (e.g., iPad®), through their respective network connections 103, can either interact directly or indirectly with the flexible payment loan system 101. For example, a network connection 103 may include wired connections (e.g., Digital Subscriber Line (DSL), optical) and/or wireless connections (e.g., Wi-Fi.) In various embodiments, a network connection 103 may include an ad hoc network, an intranet, an extranet, a virtual private network (VPN), a local area network (LAN), a wireless LAN (WLAN), a wide area network (WAN), a portion of the Internet, a portion of the Public Switched Telephone Network (PSTN), a cellular telephone network, or any combination thereof. A network connection 103 need not necessarily be the same throughout the environment 100. For example, as a smartphone moves throughout the environment, it could move from a WiFi network to a cellular data network, and could further move between various cells in a cellular data network. Various user devices 105, 106, 107, and 108 and the flexible payment loan system 101 described herein may be implemented using the example computer system illustrated in FIG. 4.

A platform to manage a flexible loan account may be hosted by the flexible payment loan system 101, which may be accessed by a user using any user device 105, 106, 107, or 108. In various embodiments, a user may apply to open an account, a loan, process a loan, make a flexible loan payment, review a flexible payment loan, or manage a flexible payment loan account via a user system 104. The user system 104 can display any interface related to the flexible payment loan system 101. For example, the user system 104 may be configured to receive a flexible payment loan input (or request) from a user, to transmit the flexible payment loan input to the flexible payment loan system 101, and to receive a flexible payment loan instruction or a flexible payment loan account summary from the flexible payment loan system 101. In one embodiment, a user may download a client component of a flexible payment loan system such as a flexible payment loan app or application.

The client component may be executed locally at a user system 104, whereas the flexible payment loan system 101 may provide back-end support for the client component. In addition, the flexible payment loan system 101 may be responsible for maintaining the user accounts, all loans including a flexible payment loan, processing inputs from users, updating user accounts, gathering user data, determining whether a user is eligible for a loan, determining whether a user is eligible for a flexible payment loan, determining the specification of a loan, reviewing whether a user's flexible payment loan is in good standing, and transmitting instructions to various user devices 105-108 of the user system 104.

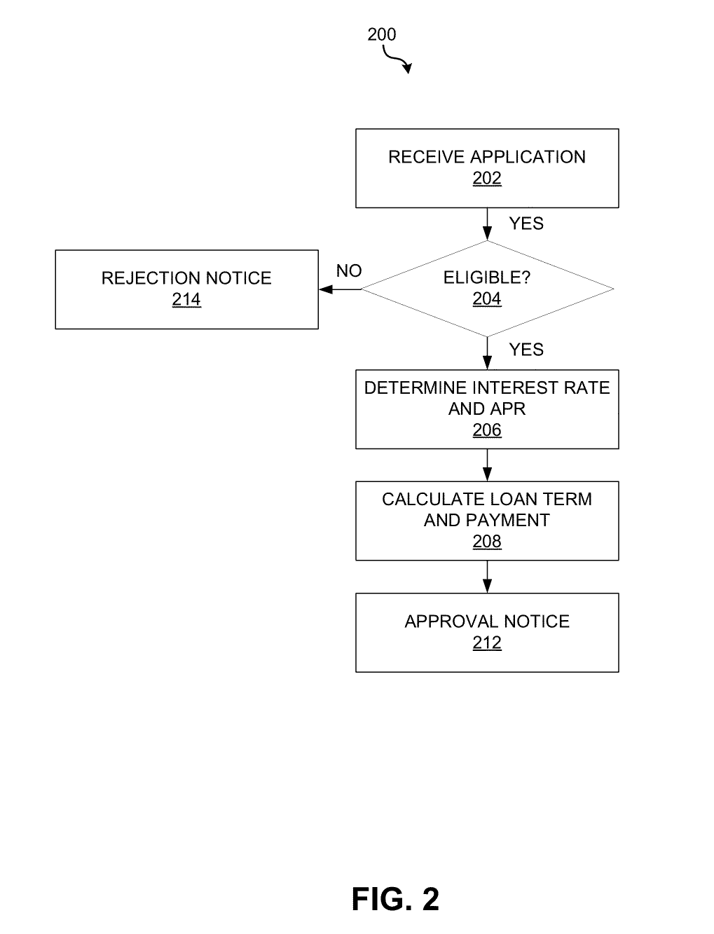

FIG. 2 is a flow diagram illustrating an exemplary method 200 of processing a flexible payment loan application, such as using the system 100 in FIG. 1. At step 202, the method receives a loan application from an applicant using a device (e.g., one of devices 105-108). In various embodiments, an applicant may apply for a flexible payment loan on his or her own or a member of the financial institution may assist an applicant with the application. The flexible payment loan may be an auto loan, a mortgage loan, an education loan, or other types of loans. In various embodiments, an applicant is required to register an account on the system 100 or with a financial institution. A flexible payment loan may be applied for by one applicant or a plurality of co-applicants.

When applying for a flexible payment loan, each applicant or co-applicant needs to provide loan application information. Exemplary information may include personal information (e.g., name, the social security number, address, employment information, the monthly income), loan type (e.g., auto loan, home loan, education loan, fixed loan, indirect/branch loan), whether or not flexible payment is desired, purpose for the loan, collateral, down payment amount, total loan amount, loan term, payment frequency, and other loan application information required by the financial institution to which the applicant is applying for the loan. The applicant may be required to pay an application or funding fee if he or she applies for a flexible payment loan.

At step 204, the applicant's eligibility for a flexible payment loan is determined. In various embodiments, a set of rules are verified to determine each applicant's eligibility. The set of rules may be maintained and updated by the flexible payment loan system 101. Various loan issuing entities or institutions may create different sets of rules. In various embodiments, each applicant's existing account with the loan issuing entities or institutions is reviewed (e.g., account balance, history of payments, whether the account is delinquent, amount of the applicant's debt). In one embodiment, each applicant's or co-applicant's credit score is compared to a predetermined minimum credit score, the loan amount is compared to a predetermined minimum loan amount, the loan term is compared to a predetermined maximum loan term, and each applicant or co-applicant's monthly income is compared to a minimum monthly income. The predetermined minimum credit score, minimum loan amount, maximum loan term, and minimum monthly income may be determined based on the loan application information including loan amount, loan term, loan payment frequency, and value of the collateral.

Additionally, in some embodiments when collateral is required, the total loan amount may be compared to the actual value of the collateral. In various embodiments, the loan to value (LTV) ratio cannot exceed a fixed percentage such as 130%. In one embodiment when the loan is an auto loan, the manufacturer's suggested retail price (MSRP), the Kelley Blue Book (KBB), or other value guides may be used to determine the actual value of the car. In various embodiments, when a new vehicle has been registered more than 90 days but a KBB value is not available, the actual value is determined to be a fraction of the MSRP such as 80% of the MSRP. In some embodiments, the value of a used vehicle includes the purchase price, tax, license, and aftermarket products. Subsequent to determining that an applicant is eligible for a loan with the financial institution, some embodiments entail confirming whether or not the applicant elects to opt out of the flexible payment. In some embodiments, applicants may not opt out of flexible payments. At step 214, subsequent to determining that an applicant is not eligible for a loan, a notice of rejection is issued.

At step 206, the interest rate and the annual percentage rate (APR) are determined for the applicant based on various factors. For example, these factors may include the applicant's credit score, the loan amount being applied, the type of the loan, the loan term and the LTV. In one embodiment, the model and year of the vehicle, the loan amount being applied, the LTV, and the applicant's credit score are used to determine the interest rate and the APR. Subsequently, at step 208, the specification of the loan is determined. In various embodiments, the specification of the loan includes the term of the loan (e.g., number of loan periods) and the payment schedule (e.g., payment frequency, number of payments, each payment amount, each payment due date, set of loan skipping periods). In various embodiments, the payment period is a calendar month, whereby loan payments are to be made monthly.

Because the loan is approved for flexible payments, an applicant is allowed to skip a predetermined number of loan payments during the loan term. The applicant does not bear additional financial charges and is not penalized for skipping loan payments as long as he or she adheres to the loan payment schedule. In various embodiments, interest continues to accrue in the payment periods when loan payments are skipped. In some embodiments, the applicant is allowed to skip one or more selected monthly loan payments each year. In one such embodiment, the loan is referred to as a Summer Saver loan and the applicant is allowed to skip loan payments in the months of July and August. In other embodiments, the applicant may choose the preferred loan payment periods to skip payments in a calendar year.

In various embodiments, the first loan payment must be made within a predetermined time period from the loan approval date. The first loan payment may be deferred by a predetermined time if the first loan payment date falls within a loan skipping period that the applicant is allowed to skip. For example, in some embodiments, the applicant must make the first monthly loan payment within forty-five (45) days from the loan approval date and the applicant is allowed to skip payments in July and August. Accordingly, if the applicant is approved for a loan on June 15^{th}, the first loan payment is not required until at minimum September 1st. Additionally, if the applicant is approved for a loan on July 11th, the first loan payment is not required until at minimum September 1st. At step 212, the applicant is notified that the loan has been approved and provided with the specification of the loan.

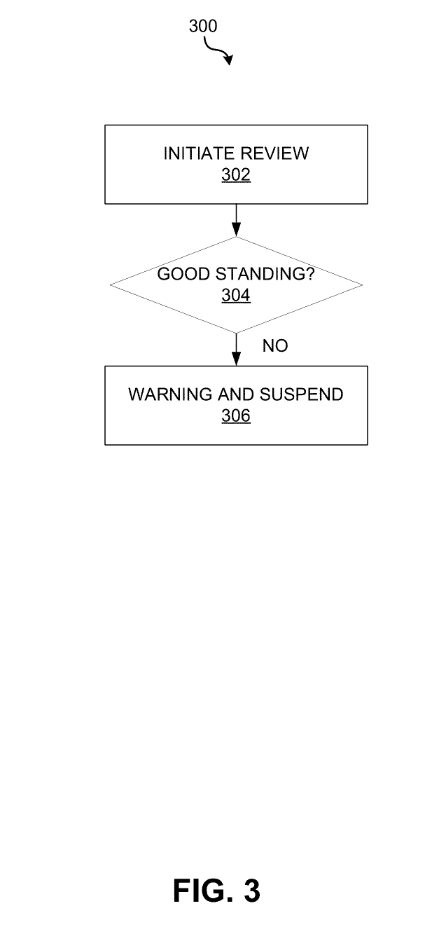

FIG. 3 illustrates an exemplary method 300 of validating the condition of a loan in accordance with an embodiment. In various embodiments, an applicant must maintain a flexible payment loan in good standing during each review period to be eligible to continuously skip loan payments. At step 302, in a review period, a review to validate the condition of a loan is initiated. In various embodiments, the review period is predetermined. By way of example, the review period may be determined in consideration of the loan payment period to be skipped (e.g., a loan skipping period). In one embodiment, June 1^{st} is the review period for a payment to be skipped in July and July 1^{st} is the review period for a payment to be skipped in August.

Step 304 involves determining whether a flexible payment loan or the account is in good standing. A loan with flexible payments is not in good standing if it satisfies one of a set of predetermined rules. In various embodiments, the loan is not in good standing if: (i) any loan of the loan holder with the financial institution is delinquent over a predetermined period (e.g., 30 days), (ii) the flexible payment loan holder has negative deposits with the financial institution (e.g., the balance in a checking account is less than a predetermined amount), or (iii) the loan holder has received a derogatory warning code or account status (e.g. account has a bankrupt status).

At step 306, upon determining that the flexible payment loan or the account is not in good standing, a warning is sent to the flexible payment loan holder indicating that loan payments cannot be skipped (i.e., flexible payments suspended). The warning may be delivered to the loan holder via various means such as regular mail, e-mail, and text messages, etc. At step 308, the status that the flexible payment loan or the account is in good standing is saved. The flexible payment loan holder may continue skipping payments in the loan skipping period which is reviewed.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 4. Various embodiments are described in terms of this example-computing module 400. After reading this description, it will become apparent to a person skilled in the relevant art how to implement the application using other computing modules or architectures.

Referring now to FIG. 4, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive might be provided. Accordingly, storage media 414 might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

While various embodiments of the present application have been described above, it should be understood that they have been presented by way of example only, and not of limitation. Likewise, the various diagrams may depict an example architectural or other configuration for the application, which is done to aid in understanding the features and functionality that can be included in the application. The application is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present application. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer-implemented method of processing flexible payment loans, comprising:
determining an applicant's eligibility for a flexible payment loan based on the applicant's personal information and information regarding the loan provided via a user computer interface;
determining a specification of a flexible payment loan based on the information provided via the user computer interface, the specification comprising an interest rate, a loan term, a loan payment period, the number of loan payments, each loan payment amount, and a set of predetermined loan skipping periods; and
providing the specification of the flexible payment loan to the applicant, wherein the applicant is allowed to skip loan payments in the set of predetermined loan skipping periods without penalty and without need for additional input from the applicant or a lender.

2. The computer-implemented method of claim 1, wherein the flexible payment loan is an auto loan, a mortgage loan, or an education loan.

3. The computer-implemented method of claim 1, wherein the loan payment period is a calendar month.

4. The computer-implemented method of claim 3, wherein the applicant makes ten loan payments in each calendar year.

5. The computer-implemented method of claim 4, wherein the applicant is allowed to skip making loan payments in the months of July and August in each calendar year.

6. The computer-implemented method of claim 1, wherein interest accrues in the set of predetermined loan skipping periods.

7. The computer-implemented method of claim 1, further comprising validating the applicant's flexible payment loan in a review period.

8. The computer-implemented method of claim 7, wherein the applicant's flexible payment loan is in good standing if it does not satisfy a set of predetermined rules.

9. The computer-implemented method of claim 7, further comprising suspending the flexible payments if the applicant's flexible payment loan is not in good standing.

10. The computer-implemented method of claim 7, wherein the review period is determined based on the timing of one of the set of predetermined loan skipping periods.

11. A non-transitory computer readable medium having computer executable program code embodied thereon, the computer executable program code configured to cause a computing device to:
determine an applicant's eligibility for a flexible payment loan based on the applicant's personal information and information regarding the loan provided via a user computer interface;
determine a specification of a flexible payment loan based on the information provided via the user computer interface, the specification comprising an interest rate, a loan term, a loan payment period, the number of loan payments, each loan payment amount, and a set of predetermined loan skipping periods; and
provide the specification of the flexible payment loan to the applicant, wherein the applicant is allowed to skip loan payments in the set of predetermined loan skipping periods without penalty and without need for additional input from the applicant or a lender.

12. The computer readable medium of claim 11, wherein the flexible payment loan is an auto loan, a mortgage loan, or an education loan.

13. The computer readable medium of claim, 11, wherein the loan payment period is a calendar month.

14. The computer readable medium of claim 13, wherein the applicant makes ten loan payments in each calendar year.

15. The computer readable medium of claim 14, wherein the applicant is allowed to skip making loan payments in the months of July and August in each calendar year.

16. The computer readable medium of claim 11, wherein interest accrues in the set of predetermined loan skipping periods.

17. The computer readable medium of claim 11, wherein the computer executable program code is further configured to cause the computing device to validate the applicant's flexible payment loan in a review period.

18. The computer readable medium of claim 17, wherein the applicant's flexible payment loan is in good standing if it does not satisfy a set of predetermined rules.

19. The computer readable medium of claim 17, wherein the computer executable program code is further configured to cause the computing device to suspend the flexible payments if the applicant's flexible payment loan is not in good standing.

20. The computer readable medium of claim 17, wherein the review period is determined based on the timing of one of the set of predetermined loan skipping periods.

21. The computer-implemented method of claim 1, wherein the information regarding the loan provided via a user computer interface includes a user chosen set of loan skipping periods.

22. The computer readable medium of claim 11, wherein the information regarding the loan provided via a user computer interface includes a user chosen set of loan skipping periods.
